(19) United States
(12) Patent Application Publication
(10) Pub. No.: US 2026/0092903 A1
(43) Pub. Date: Apr. 2, 2026

(54) ULTRASOUND PROBE

(71) Applicant: FUJIFILM Corporation, Tokyo (JP)

(72) Inventors: Shinsuke NOGUCHI, Kanagawa (JP); Hideki YAMAGISHI, Kanagawa (JP)

(73) Assignee: FUJIFILM Corporation, Tokyo (JP)

(21) Appl. No.: 19/312,263

(22) Filed: Aug. 27, 2025

(30) Foreign Application Priority Data
Sep. 30, 2024 (JP) 2024-170031

(51) Int. Cl. G01N 29/32; G01N 29/24

(52) U.S. Cl. CPC G01N 29/326; G01N 29/2437; G01N 29/2481

(57) ABSTRACT

Provided is an ultrasound probe that can reduced in size while suppressing an increase in temperature due to heat generated from an integrated circuit.

An ultrasound probe includes a heat transfer member that is sheet-like and that is disposed between an inner surface of a housing and an integrated circuit so as to cover at least a periphery of the integrated circuit, and a heat transfer control member that is sheet-like, that is disposed between the heat transfer member and the integrated circuit so as to cover at least the periphery of the integrated circuit, and that controls heat conduction between the integrated circuit and the heat transfer member, in which the heat transfer control member is in contact with the heat transfer member, and a contact area per unit area, directly above the integrated circuit, between the heat transfer control member and the heat transfer member is smaller than a contact area per unit area, in the periphery of the integrated circuit, between the heat transfer control member and the heat transfer member.

### CROSS-REFERENCE TO RELATED APPLICATIONS

The present application claims priority under 35 U.S.C. § 119 to Japanese Patent Application No. 2024-170031, filed on Sep. 30, 2024. The above application is hereby expressly incorporated by reference, in its entirety, into the present application.

### BACKGROUND OF THE INVENTION

### 1. Field of the Invention

The present invention relates to an ultrasound probe, and more particularly to an ultrasound probe with an integrated circuit disposed inside a grip portion of a housing.

### 2. Description of the Related Art

In related art, an ultrasound diagnostic apparatus using ultrasound images is put into practical use in the medical field. In general, such an ultrasound diagnostic apparatus comprises an ultrasound probe in which a transducer array is built and a diagnostic apparatus body connected to the ultrasound probe, in which an ultrasound image is generated by transmitting an ultrasound beam from the ultrasound probe toward a subject, receiving an ultrasound echo from the subject by the ultrasound probe, and electrically processing the received signal.

In recent years, an ultrasound diagnostic apparatus in which an integrated circuit for generating an ultrasound image from a signal received by a transducer array is disposed inside an ultrasound probe, the ultrasound image generated in the ultrasound probe is transmitted to a diagnostic apparatus body, and the ultrasound image is displayed on a monitor of the diagnostic apparatus body has been developed. In such an ultrasound diagnostic apparatus, since the ultrasound image is generated in the ultrasound probe, a general-purpose portable thin computer can be used as the diagnostic apparatus body.

However, it is known that the integrated circuit performs signal processing of generating the ultrasound image based on the signal received by the transducer array and generates heat during the operation. Therefore, it is desired to suppress an increase in temperature in a housing of the ultrasound probe.

Therefore, JP2013-52023A discloses an ultrasound probe comprising a temperature increase suppression member that suppresses an increase in temperature due to heat generated from an integrated circuit in a housing of the ultrasound probe.

### SUMMARY OF THE INVENTION

However, the temperature increase suppression member used in the ultrasound probe disclosed in JP2013-52023A has a complicated configuration including a heat reception member with high emissivity achieved by applying ceramic coating to a surface of a material having high thermal conductivity, a heat diffusion member that extends from a front end portion to a rear end portion of the housing along an inner surface of the housing, a heat conduction member that is disposed to surround an integrated circuit and that conducts heat generated from the integrated circuit to the heat diffusion member, and a heat dissipation member that is disposed on the heat conduction member and that releases infrared rays toward the heat reception member by the heat of the heat diffusion member. In order to accommodate such a temperature increase suppression member, there is a problem in that a thickness dimension of the housing particularly increases and the size of the ultrasound probe increases.

The present invention has been made in order to solve such a problem in the related art, and an object of the present invention is to provide an ultrasound probe that can be reduced in size while suppressing an increase in temperature due to heat generated from an integrated circuit.

The above object can be achieved with the following configurations.
[1] An ultrasound probe in which an integrated circuit is disposed inside a grip portion of a housing, the ultrasound probe comprising: a heat transfer member that is sheet-like and that is disposed between an inner surface of the housing and the integrated circuit so as to cover at least a periphery of the integrated circuit; and a heat transfer control member that is sheet-like, that is disposed between the heat transfer member and the integrated circuit so as to cover at least the periphery of the integrated circuit, and that controls heat conduction between the integrated circuit and the heat transfer member, in which the heat transfer control member is in contact with the heat transfer member, and a contact area per unit area, directly above the integrated circuit, between the heat transfer control member and the heat transfer member is smaller than a contact area per unit area, in the periphery of the integrated circuit, between the heat transfer control member and the heat transfer member.
[2] An ultrasound probe in which an integrated circuit is disposed inside a grip portion of a housing, the ultrasound probe comprising: a heat transfer member that is sheet-like and that is disposed between an inner surface of the housing and the integrated circuit so as to cover at least a periphery of the integrated circuit; and a heat dissipation control member that is sheet-like, that is disposed between the heat transfer member and the inner surface of the housing so as to cover at least the periphery of the integrated circuit, and that controls heat dissipation from the heat transfer member to the housing, in which the heat dissipation control member is in contact with the inner surface of the housing, and a contact area per unit area, directly above the integrated circuit, between the heat dissipation control member and the inner surface of the housing is smaller than a contact area per unit area, in the periphery of the integrated circuit, between the heat dissipation control member and the inner surface of the housing.
[3] The ultrasound probe according to [1] or [2], in which the heat transfer member has at least one opening portion located directly above the integrated circuit.
[4] The ultrasound probe according to [1] or [2], in which the heat transfer member is made of an anisotropic thermally conductive material having thermal conductivity higher in a plane direction thereof than in a thickness direction thereof.
[5] The ultrasound probe according to [1] or [2], in which at least a portion of a surface of the heat transfer member that faces the integrated circuit is subjected to an electrical insulation treatment.
[6] The ultrasound probe according to [1] or [2], in which the heat transfer member is disposed to cover an entire rear surface of the grip portion of the housing.
[7] The ultrasound probe according to [6], in which the heat transfer member has at least one slit formed along a longitudinal direction of the housing or has a tape shape with a width narrower than a width of the housing.
[8] The ultrasound probe according to [1] or [2], further comprising: at least one of a temperature sensor or a wireless communication circuit, in which the heat transfer member is disposed so as to cover at least one of the temperature sensor or the wireless communication circuit, and the heat transfer member has an opening portion corresponding to at least one of the temperature sensor or the wireless communication circuit.
[9] The ultrasound probe according to [1], in which the heat transfer control member has a plurality of recess portions formed on a surface that faces the heat transfer member, and the plurality of recess portions have an arrangement pattern corresponding to the integrated circuit.

The ultrasound probe according to [2], in which the heat dissipation control member has a plurality of recess portions formed on a surface that faces the inner surface of the housing, and the plurality of recess portions are arranged in a pattern corresponding to a position of the integrated circuit.

The ultrasound probe comprises: the heat transfer member that is sheet-like and that is disposed between the inner surface of the housing and the integrated circuit so as to cover at least the periphery of the integrated circuit; and the heat transfer control member that is sheet-like, that is disposed between the heat transfer member and the integrated circuit so as to cover at least the periphery of the integrated circuit, and that controls heat conduction between the integrated circuit and the heat transfer member, the heat transfer control member is in contact with the heat transfer member, and the contact area per unit area, directly above the integrated circuit, between the heat transfer control member and the heat transfer member is smaller than the contact area per unit area, in the periphery of the integrated circuit, between the heat transfer control member and the heat transfer member, so that it is possible to provide the ultrasound probe that can be reduced in size while suppressing the increase in temperature due to the heat generated from the integrated circuit.

### BRIEF DESCRIPTION OF THE DRAWINGS

FIG. 1 is a perspective view showing an ultrasound probe according to a first embodiment of the present invention.

FIG. 2 is a plan view showing the ultrasound probe according to the first embodiment of the present invention.

FIG. 3 is a side view showing the ultrasound probe according to the first embodiment of the present invention.

FIG. 4 is a cross-sectional view showing an internal configuration of the ultrasound probe according to the first embodiment of the present invention.

FIG. 5 is a cross-sectional view showing a configuration of a peripheral portion of an integrated circuit in the ultrasound probe according to the first embodiment of the present invention.

FIG. 6 is a plan view showing a configuration of the peripheral portion of the integrated circuit in the ultrasound probe according to the first embodiment of the present invention.

FIG. 7 is a block diagram showing a configuration of an ultrasound diagnostic apparatus comprising the ultrasound probe according to the first embodiment of the present invention.

FIG. 8 is a block diagram showing an internal configuration of a transmission/reception circuit of the ultrasound probe according to the first embodiment of the present invention.

FIG. 9 is a block diagram showing an internal configuration of an image generation unit of the ultrasound probe according to the first embodiment of the present invention.

FIG. 10 is a cross-sectional view showing a configuration of a peripheral portion of an integrated circuit in an ultrasound probe according to a modification example of the first embodiment of the present invention.

FIG. 11 is a plan view showing a heat transfer member used in an ultrasound probe according to another modification example of the first embodiment of the present invention.

FIG. 12 is a cross-sectional view showing a configuration of a peripheral portion of an integrated circuit in an ultrasound probe according to a second embodiment of the present invention.

FIG. 13 is a plan view showing a configuration of the peripheral portion of the integrated circuit in the ultrasound probe according to the second embodiment of the present invention.

FIG. 14 is a cross-sectional view showing a configuration of a peripheral portion of an integrated circuit in an ultrasound probe according to a modification example of the second embodiment of the present invention.

FIG. 15 is a block diagram showing a configuration of an ultrasound diagnostic apparatus comprising an ultrasound probe according to a third embodiment of the present invention.

### DESCRIPTION OF THE PREFERRED EMBODIMENTS

Hereinafter, embodiments of the present invention will be described with reference to the drawings.

The following configuration requirements are described based on representative embodiments of the present invention, but the present invention is not limited to the embodiment.

In the present specification, a numerical range represented by “to” means a range including numerical values described before and after “to”, both ends inclusive, as lower limit and upper limit values.

In the present specification, “same” and “identical” include an error range which is generally allowed in the technical field.

### First Embodiment

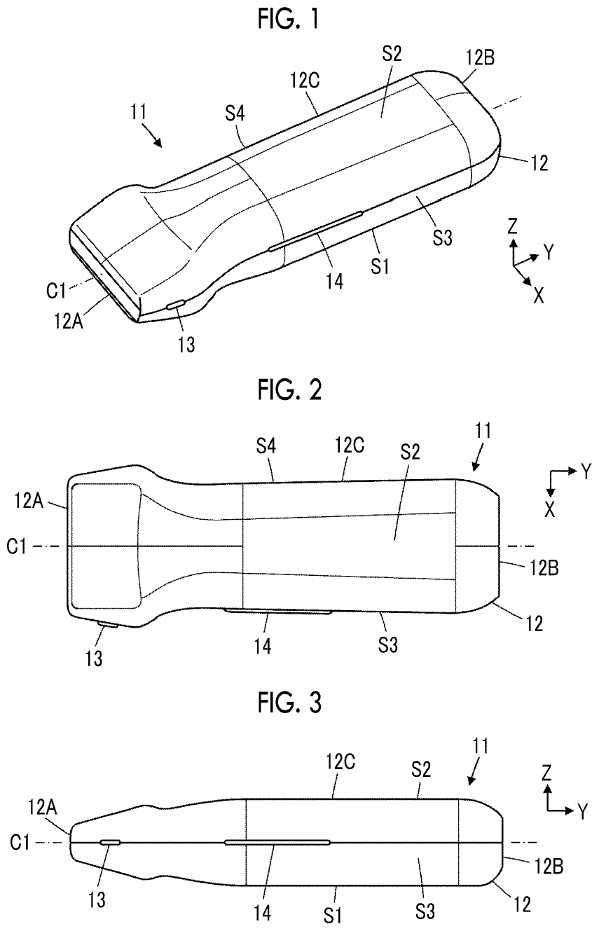

FIGS. 1 to 3 show an ultrasound probe 11 according to a first embodiment of the present invention. The ultrasound probe 11 comprises a housing 12, and the housing 12 extends in a predetermined direction as a whole and has a flat and wide shape. The housing 12 has a front end portion 12A disposed at one end portion in an extending direction, a rear end portion 12B disposed at the other end portion, and a grip portion 12C disposed between the front end portion 12A and the rear end portion 12B. The grip portion 12C is a portion gripped by a user in a case in which ultrasound diagnosis is performed using the ultrasound probe 11.

Here, for convenience, a direction from the front end portion 12A toward the rear end portion 12B will be referred to as a +Y direction, a width direction of the flat and wide housing 12 that is perpendicular to a Y direction will be referred to as an X direction, and a direction perpendicular to both the X direction and the Y direction will be referred to as a Z direction.

The housing 12 is made of, for example, an insulating resin, and the grip portion 12C has a tubular shape surrounded by four side plate portions extending along a center line C1 extending from the front end portion 12A to the rear end portion 12B. The four side plate portions are composed of a first side plate portion S1 directed in a-Z direction, a second side plate portion S2 directed in a +Z direction on a side opposite to the first side plate portion S1, a third side plate portion S3 connecting the first side plate portion S1 and the second side plate portion S2 and directed in a +X direction, and a fourth side plate portion S4 connecting the first side plate portion S1 and the second side plate portion S2 and directed in a-X direction.

As shown in FIG. 3, the housing 12 has an outer shape in which a thickness in the Z direction gradually decreases from a vicinity of a center portion in the Y direction toward the front end portion 12A along the center line C1, although there is a slight protrusion portion in a case of being viewed in the X direction.

In addition, a protrusion 13 for indicating an orientation of the ultrasound probe 11 is formed to protrude on the +X direction side of the front end portion 12A, and a light-emitting unit 14 extending in the Y direction along the center line C1 is disposed on an outer surface of the third side plate portion S3.

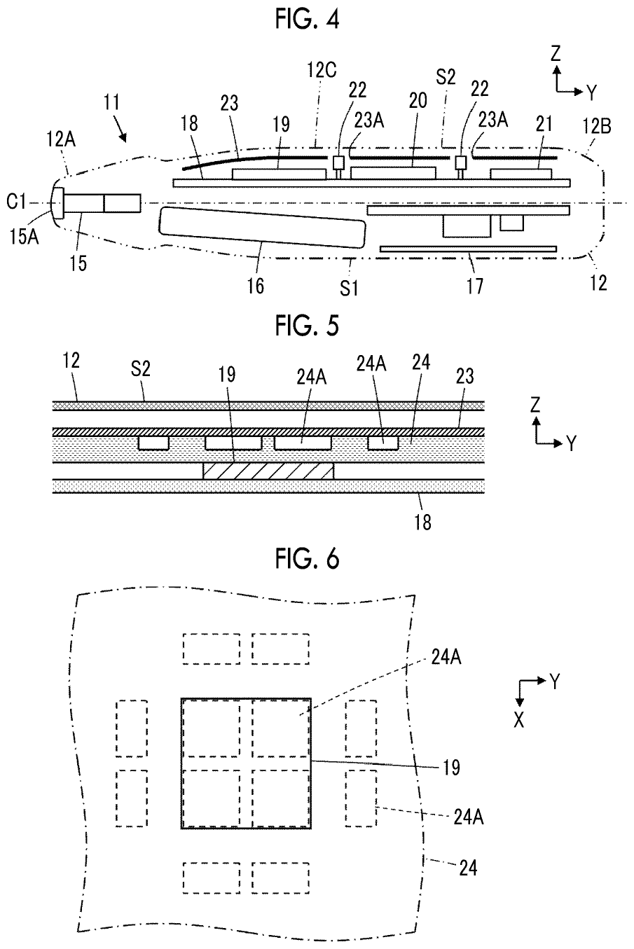

FIG. 4 shows an internal configuration of the ultrasound probe 11.

A transducer array 15 is disposed inside the front end portion 12A of the ultrasound probe 11. The transducer array 15 includes a plurality of transducers arranged in the X direction, and an ultrasound emission surface 15A of the transducer array 15 is exposed from the housing 12 and directed in the −Y direction.

A flat plate-shaped battery 16 is disposed inside the housing 12 at a position offset toward the front end portion 12A side from the grip portion 12C so as to lie along an inner surface of the housing 12. The battery 16 is disposed to be offset toward the −Z direction side with respect to the center line C1.

As described above, since the housing 12 has the outer shape in which the thickness in the Z direction gradually decreases from the vicinity of the center portion in the Y direction toward the front end portion 12A along the center line C1, the battery 16 is disposed at a position offset toward the front end portion 12A side from the grip portion 12C so as to lie along the inner surface of the housing 12, so that the battery 16 is in a state of being inclined relative to the center line C1.

A power receive coil 17 is disposed on the +Y direction side of the battery 16 at a position offset toward the −Z direction side with respect to the center line C1. The power receive coil 17 has a thinner flat plate shape than the battery 16 and is disposed along an inner surface of the first side plate portion S1 of the grip portion 12C. Here, at least a region of the first side plate portion S1 in which the power receive coil 17 is disposed has a planar inner surface and a planar outer surface, and the power receive coil 17 is disposed in a state of being in contact with the inner surface of the first side plate portion S1 or being extremely close to the inner surface of the first side plate portion S1.

In addition, inside the housing 12, a circuit board 18 is disposed at a position offset toward a side opposite to the battery 16 and the power receive coil 17 with respect to the center line C1, that is, inside the second side plate portion S2 of the grip portion 12C. The circuit board 18 extends from the grip portion 12C to the vicinity of the transducer array 15 of the front end portion 12A along an XY plane, and two integrated circuits 19 and 20 and a wireless communication circuit 21 are sequentially mounted on a front surface of the circuit board 18 on the +Z direction side along the center line C1 in the +Y direction.

Furthermore, two temperature sensors 22 connected to the circuit board 18 are disposed inside the housing 12. Among the two temperature sensors 22, one temperature sensor 22 is located between the two integrated circuits 19 and 20, and the other temperature sensor 22 is located between the integrated circuit 20 and the wireless communication circuit 21, and each of the temperature sensors 22 is disposed close to an inner surface of the second side plate portion S2 of the grip portion 12C.

In addition, a sheet-like heat transfer member 23 is disposed between the circuit board 18 and the inner surface of the second side plate portion S2 of the grip portion 12C, and the two integrated circuits 19 and 20 and the wireless communication circuit 21 mounted on the circuit board 18 are covered with the heat transfer member 23. The heat transfer member 23 consists of a sheet-like member having high thermal conductivity, but has two opening portions 23A formed corresponding to the positions at which the two temperature sensors 22 are disposed, and the two temperature sensors 22 face the inner surface of the second side plate portion S2 through the corresponding opening portions 23A of the heat transfer member 23.

In the vicinity of the integrated circuit 19, as shown in FIG. 5, a sheet-like heat transfer control member 24 is disposed between the heat transfer member 23 and the integrated circuit 19. The heat transfer control member 24 consists of a sheet-like member having high thermal conductivity, similarly to the heat transfer member 23, and a front surface of the heat transfer control member 24 on the +Z direction side is in contact with the heat transfer member 23, and a rear surface of the heat transfer control member 24 on the −Z direction side is in contact with the front surface of the integrated circuit 19.

Further, a plurality of recess portions 24A are formed on the front surface of the heat transfer control member 24 on the +Z direction side facing the heat transfer member 23. The plurality of recess portions 24A have an arrangement pattern corresponding to the integrated circuit 19, and, for example, as shown in FIG. 6, the recess portions 24A are disposed in portions having a large area ratio with respect to the front surface of the integrated circuit 19 directly above the integrated circuit 19, and the disposition of the recess portions 24A is limited to a relatively small area portion in the periphery of the integrated circuit 19.

The front surface of the heat transfer control member 24 on the +Z direction side is in contact with the heat transfer member 23, but since the recess portion 24A is formed on the front surface of the heat transfer control member 24 on the +Z direction side, the heat transfer control member 24 and the heat transfer member 23 are not in direct contact with each other in a portion in which the recess portion 24A is present.

Therefore, due to the presence of the plurality of recess portions 24A having the arrangement pattern corresponding to the integrated circuit 19, a contact area per unit area, directly above the integrated circuit 19, between the heat transfer control member 24 and the heat transfer member 23 is smaller than a contact area per unit area, in the periphery of the integrated circuit 19, between the heat transfer control member 24 and the heat transfer member 23. Here, the “unit area” means a region having the same area, which is determined in the periphery of the integrated circuit 19 and directly above the integrated circuit 19 in a case of comparing the contact area between the heat transfer control member 24 and the heat transfer member 23. For example, in a case in which the comparison is performed by using the area occupied by the front surface of the integrated circuit 19 on the +Z direction side as the unit area, the contact area, directly above the integrated circuit 19, between the heat transfer control member 24 and the heat transfer member 23 is smaller than the contact area, in the periphery of the integrated circuit 19, between the heat transfer control member 24 and the heat transfer member 23.

Therefore, the heat generated in the integrated circuit 19 is not easily transferred to the heat transfer member 23 of the portion located directly above the integrated circuit 19, while the heat is easily transferred to the heat transfer member 23 of the portion located in the periphery of the integrated circuit 19. In this manner, the heat conduction between the integrated circuit 19 and the heat transfer member 23 is controlled by the heat transfer control member 24.

In addition, the sheet-like heat transfer control member 24 is also disposed between the integrated circuit 20 and the wireless communication circuit 21 mounted on the circuit board 18 and the heat transfer member 23. As in a case of the integrated circuit 19, the heat transfer control member 24 controls the heat conduction between the integrated circuit 20 and the wireless communication circuit 21 and the heat transfer member 23 such that the heat generated in the integrated circuit 20 and the wireless communication circuit 21 is less likely to be transferred to the heat transfer member 23 located directly above the integrated circuit 20 and the wireless communication circuit 21, and is more likely transferred to the heat transfer member 23 located in the periphery of the integrated circuit 20 and the wireless communication circuit 21.

As a material for forming the heat transfer member 23, a copper sheet, a heat dissipation gel, a graphite sheet, and the like can be used. Here, as the heat dissipation gel, for example, a gel-like material containing silicone as a main raw material, an acrylic gel-like material, and the like can be used.

In a case in which the heat transfer member 23 is made of the copper sheet or the heat dissipation gel, the heat transfer control member 24 can be made of the heat dissipation gel, the graphite sheet, the aluminum heat sink, the heat dissipation resin, or the like. Here, the heat dissipation resin is a resin material having high heat dissipation properties, and, for example, a nylon resin, particularly a nylon resin blended with a thermally conductive filler can be used as the heat dissipation resin.

In a case in which the heat transfer member 23 is made of the graphite sheet, the heat transfer control member 24 can be made of the heat dissipation gel, the aluminum heat sink, the heat dissipation resin, or the like.

Further, in a case in which the heat transfer member 23 is made of an anisotropic thermally conductive material having characteristics that the thermal conductivity is higher in a plane direction of the heat transfer member 23, than in a thickness direction of the heat transfer member 23, the heat generated by the heat generating bodies such as the integrated circuits 19 and 20 and the wireless communication circuit 21 can be efficiently conducted to a location away from the heat generating bodies. In a case in which the heat transfer member 23 is made of such an anisotropic thermally conductive material, the thickness of the heat transfer member 23 can be reduced while maintaining the thermally conductive properties.

In addition, in order to ensure electrical insulation, it is desirable to perform an electrical insulation treatment on at least a surface of the heat transfer member 23 facing the integrated circuits 19 and 20 and the wireless communication circuit 21.

Further, the heat transfer member 23 and the heat transfer control member 24 can be held inside the housing 12, for example, by being interposed between the circuit board 18 and the inner surface of the housing 12.

However, instead of interposing the heat transfer member 23 and the heat transfer control member 24, the heat transfer member 23 and the heat transfer control member 24 may be held inside the housing 12 by, for example, adhering to the inner surface of the housing 12.

In FIG. 5, the rear surface of the heat transfer control member 24 on the −Z direction side is in contact with the front surface of the integrated circuit 19, but the heat transfer control member 24 and the integrated circuit 19 do not always need to be in contact with each other and may be separated from each other in the Z direction.

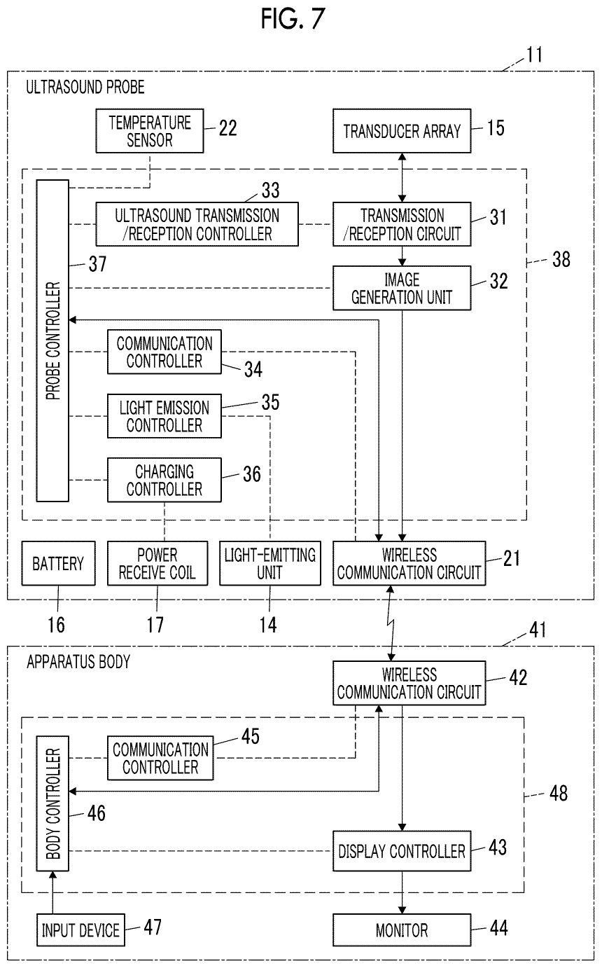

Hereinafter, FIG. 7 shows a configuration of an ultrasound diagnostic apparatus comprising the ultrasound probe 11 according to the first embodiment. The ultrasound diagnostic apparatus comprises the ultrasound probe 11 and an apparatus body 41 according to the first embodiment, and the ultrasound probe 11 and the apparatus body 41 are connected to each other by wireless communication.

The ultrasound probe 11 has a transmission/reception circuit 31 connected to the transducer array 15, and an image generation unit 32 and the wireless communication circuit 21 are sequentially connected to the transmission/reception circuit 31. In addition, an ultrasound transmission/reception controller 33 is connected to the transmission/reception circuit 31. Further, a communication controller 34 is connected to the wireless communication circuit 21, a light emission controller 35 is connected to the light-emitting unit 14, and a charging controller 36 is connected to the power receive coil 17. In addition, a probe controller 37 is connected to the temperature sensors 22, the ultrasound transmission/reception controller 33, the communication controller 34, the light emission controller 35, and the charging controller 36. The power receive coil 17 is connected to the battery 16. Here, the wireless communication circuit 21 and the probe controller 37 are connected to each other so as to enable bidirectional exchange of information.

Further, a processor 38 on the ultrasound probe 11 side is formed by the transmission/reception circuit 31, the image generation unit 32, the ultrasound transmission/reception controller 33, the communication controller 34, the light emission controller 35, the charging controller 36, and the probe controller 37.

The apparatus body 41 comprises a wireless communication circuit 42, and a display controller 43 and a monitor 44 are sequentially connected to the wireless communication circuit 42. In addition, a communication controller 45 is connected to the wireless communication circuit 42, and a body controller 46 is connected to the wireless communication circuit 42, the display controller 43, and the communication controller 45. In addition, an input device 47 is connected to the body controller 46. Here, the wireless communication circuit 42 and the body controller 46 are connected to each other so as to enable bidirectional exchange of information.

Further, a processor 48 on the apparatus body 41 side is formed by the display controller 43, the communication controller 45, and the body controller 46.

In addition, the wireless communication circuit 21 of the ultrasound probe 11 and the wireless communication circuit 42 of the apparatus body 41 are connected to each other so as to enable bidirectional exchange of information, so that the ultrasound probe 11 and the apparatus body 41 are connected to each other by wireless communication.

The transducer array 15 of the ultrasound probe 11 includes a plurality of transducers arranged in a one-dimensional or two-dimensional manner. Each of these transducers transmits ultrasound waves in accordance with a drive signal supplied from the transmission/reception circuit 31, receives an ultrasound echo from a subject, and outputs a received signal. Each transducer is formed by, for example, forming electrodes on both ends of a piezoelectric body consisting of a piezoelectric single crystal represented by lead zirconate titanate (PZT), a polymeric piezoelectric element represented by poly vinylidene di fluoride (PVDF), or a piezoelectric single crystal represented by lead magnesium niobate-lead titanate (PMN-PT) solid solution.

The ultrasound transmission/reception controller 33 controls the transmission/reception circuit 31 to transmit an ultrasound beam and receive the ultrasound echo based on an instruction from the probe controller 37.

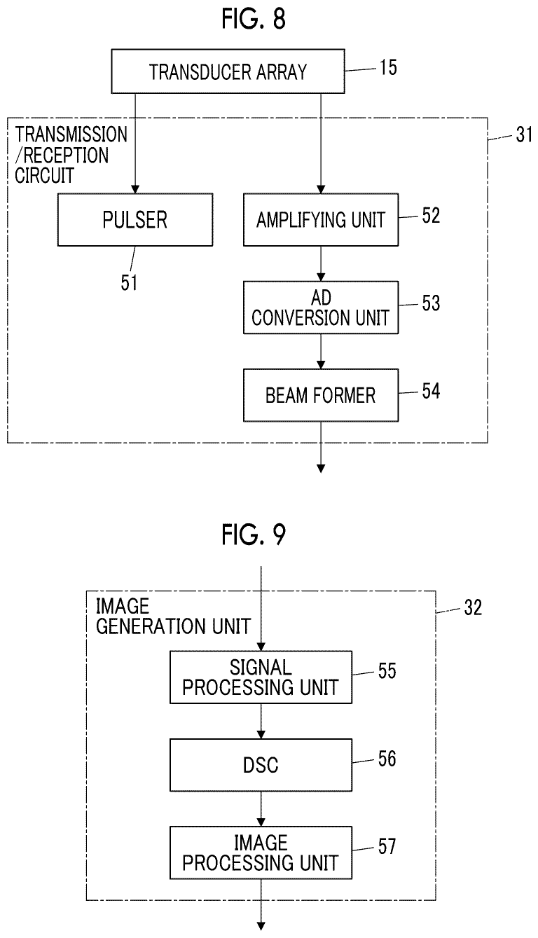

The transmission/reception circuit 31 transmits the ultrasound waves from the transducer array 15 and generates a sound ray signal based on the received signal acquired by the transducer array 15, under the control of the ultrasound transmission/reception controller 33. The transmission/reception circuit 31 includes, as shown in FIG. 8, a pulser 51 connected to the transducer array 15, and an amplifying unit 52, an analog-digital (AD) conversion unit 53, and a beam former 54 which are sequentially connected in series to the transducer array 15.

The pulser 51 includes, for example, a plurality of pulse generators, and supplies each of drive signals to the plurality of transducers by adjusting a delay amount such that the ultrasound waves transmitted from the plurality of transducers of the transducer array 15 form an ultrasound beam based on a transmission delay pattern selected in response to a control signal from the ultrasound transmission/reception controller 33. As described above, in a case in which a pulsed or continuous wave voltage is applied to the electrodes of the transducers of the transducer array 15, the piezoelectric body expands and contracts to generate a pulsed or continuous wave ultrasound wave from each transducer, and the ultrasound beam is formed from the combined wave of these ultrasound waves.

The transmitted ultrasound beam is reflected by a target, for example, a part of the subject, and an ultrasound echo propagates toward the transducer array 15 of the ultrasound probe 11. The ultrasound echo propagating toward the transducer array 15 in this manner is received by each of the transducers constituting the transducer array 15. In such a case, each transducer constituting the transducer array 15 expands and contracts by receiving the propagating ultrasound echo to generate the received signal that is an electric signal, and outputs the received signal to the amplifying unit 52.

The amplifying unit 52 amplifies the signal input from each of the transducers constituting the transducer array 15 and transmits the amplified signal to the AD conversion unit 53. The AD conversion unit 53 converts the signal transmitted from the amplifying unit 52 into digital reception data, and transmits the reception data to the beam former 54. The beam former 54 performs so-called reception focus processing by giving and adding delay with respect to each reception data converted by the AD conversion unit 53, in accordance with a sound velocity or a sound velocity distribution set based on a reception delay pattern selected in accordance with a control signal from the ultrasound transmission/reception controller 33. By the reception focus processing, each reception data, which is converted by the AD conversion unit 53, is phase-added, and the sound ray signal in which the focus of the ultrasound echo is narrowed down is generated. The sound ray signal generated in this way is sent to the image generation unit 32.

As shown in FIG. 9, the image generation unit 32 has a configuration in which a signal processing unit 55, a digital scan converter (DSC) 56, and an image processing unit 57 are sequentially connected in series.

The signal processing unit 55 performs correction of attenuation due to a distance in accordance with a depth of a reflection position of the ultrasound waves on the sound ray signal sent from the transmission/reception circuit 31, and then performs envelope detection processing to generate an image signal (B-mode image signal) which is tomographic image information related to a tissue in the subject.

The DSC 56 converts (raster-converts) the image signal generated by the signal processing unit 55 into an image signal in accordance with a normal television signal scanning method.

The image processing unit 57 performs various types of necessary image processing, such as brightness correction, gradation correction, sharpness correction, and color correction, on the image signal input from the DSC 56, to generate an ultrasound image signal. The ultrasound image signal generated by the image generation unit 32 in this way is sent to the wireless communication circuit 21.

The wireless communication circuit 21 includes an antenna for transmitting and receiving radio waves, and performs wireless communication with the wireless communication circuit 42 of the apparatus body 41. In this case, the wireless communication circuit 21 modulates a carrier based on the image signal sent from the image generation unit 32 to generate a transmission signal, and wirelessly transmits the generated transmission signal to the wireless communication circuit 42 of the apparatus body 41. As the carrier modulation method, for example, amplitude shift keying (ASK), phase shift keying (PSK), quadrature phase shift keying (QPSK), 16 quadrature amplitude modulation (16QAM), or the like is used.

The communication controller 34 controls the wireless communication circuit 21 such that the ultrasound image signal is transmitted with a transmission radio field intensity set by the probe controller 37.

The light emission controller 35 controls the light emission of the light-emitting unit 14 disposed on the outer surface of the third side plate portion S3 of the housing 12 such that various states of the ultrasound probe 11 are represented, under the control of the probe controller 37.

In a case in which the ultrasound probe 11 is disposed in a charger described later, the charging controller 36 controls charging of the battery 16 via the power receive coil 17 with respect to the battery 16 and the power receive coil 17 built in the housing 12.

The temperature sensors 22 disposed inside the housing 12 detect a temperature inside the housing 12, particularly, a temperature in the vicinity of the inner surface of the second side plate portion S2 of the grip portion 12C, and sends the detected temperature to the probe controller 37.

The battery 16 supplies the power to each unit in the ultrasound probe 11.

The power receive coil 17 receives charging power transmitted from a charger disposed outside the ultrasound probe 11.

The probe controller 37 performs control of each unit in the ultrasound probe 11 based on a program or the like stored in advance.

The wireless communication circuit 42 of the apparatus body 41 includes an antenna for transmitting and receiving radio waves, and performs wireless communication with the wireless communication circuit 21 of the ultrasound probe 11. In this case, the wireless communication circuit 42 of the apparatus body 41 receives, for example, a transmission signal wirelessly transmitted from the wireless communication circuit 21 of the ultrasound probe 11 through the antenna, demodulates the received transmission signal, and outputs the ultrasound image signal. The wireless communication circuit 42 of the apparatus body 41 sends the ultrasound image signal output in this way to the display controller 43.

The display controller 43 performs predetermined processing on the ultrasound image signal sent from the wireless communication circuit 42 under the control of the body controller 46, and displays the ultrasound image on the monitor 44.

The monitor 44 displays the ultrasound image under the control of the display controller 43, and includes, for example, a display device such as a liquid crystal display (LCD) or an organic electroluminescence display (organic EL display).

The communication controller 45 controls the wireless communication circuit 42 of the apparatus body 41 such that the wireless communication circuit 42 receives the transmission signal from the wireless communication circuit 21 of the ultrasound probe 11.

The body controller 46 controls each unit of the apparatus body 41 based on a program stored in advance and an operation by the user via the input device 47.

The input device 47 is an input device for the user to perform an input operation, and is configured by, for example, a device such as a keyboard, a mouse, a trackball, a touchpad, and a touch sensor disposed in a state of being superimposed on the monitor 44.

In the present embodiment, each processing is executed by any computer. Moreover, any computer may execute these processes by a processor as hardware, a program as software, or a combination thereof. In such a case, the processor is configured to execute various types of processing according to the present embodiment in cooperation with the program, and can function as each unit or each means in the present embodiment. Further, the execution order of the processing by the processor is not limited to the above-described order and may be changed as appropriate. Any computer may be a general-purpose computer, a computer for specific use, a workstation, or another system capable of executing each processing.

Here, each of the processor 38 on the ultrasound probe 11 side and the processor 48 on the apparatus body 41 side may be configured by one or a plurality of types of hardware, and the type of the hardware is not limited. For example, the processor may be configured by hardware such as a central processing unit (CPU), a micro processing unit (MPU), a programmable logic device such as a field programmable gate array (FPGA), a dedicated circuit such as an application specific integrated circuit (ASIC) for executing specific processing, a graphic processing unit (GPU), or a neural processing unit (NPU). Moreover, the type of hardware may be a combination of different types of hardware. In a case in which a plurality of types of hardware are configured to execute one or a plurality of types of processing of a certain processor, the plurality of types of hardware may exist in devices physically separated from each other or may exist in the same device. Further, in any embodiment, the order of each processing executed by the processor is not limited to the above-described order, and may be changed as appropriate. The hardware is configured by an electric circuit (circuitry) in which circuit elements, such as semiconductor elements, are combined, or the like.

In the first embodiment, the processor 38 on the ultrasound probe 11 side is configured by two integrated circuits 19 and 20 shown in FIG. 4.

Furthermore, the program may be software such as firmware or a microcode. The program may be, for example, a program module group, and each function thereof may be implemented by a processor configured to execute each function. The program may be a program code or a plurality of code segments stored in one or a plurality of non-transitory computer-readable media (for example, a storage medium and other storages). The program may be stored in the plurality of non-transitory computer-readable media present in devices physically separated from each other. The program code or the code segment may represent any combination of procedures, functions, subprograms, routines, subroutines, modules, software packages, classes, instructions, data structures, or program statements. The program code or the code segment may be connected to another code segment or a hardware circuit by transmitting and receiving information, data, arguments, parameters, or contents in the memory.

In a case in which ultrasound diagnosis is performed by the ultrasound diagnostic apparatus shown in FIG. 7, first, under the control of the ultrasound transmission/reception controller 33 of the ultrasound probe 11, ultrasound beams are transmitted into the subject from the plurality of transducers of the transducer array 15 in accordance with the drive signal from the transmission/reception circuit 31. The ultrasound echo from the subject is received by the plurality of transducers of the transducer array 15, and the received signal, which is an analog signal, is output from the plurality of transducers to the transmission/reception circuit 31. The received signal is amplified by the amplifying unit 52 of the transmission/reception circuit 31, is subjected to AD conversion by the AD conversion unit 53, and is subjected to reception focus processing by the beam former 54, so that the sound ray signal is generated, and the sound ray signal is sent from the transmission/reception circuit 31 to the image generation unit 32.

Further, the image generation unit 32 generates the image signal, which is the tomographic image information related to the tissue in the subject, by performing correction of attenuation of the sound ray signal by the distance in accordance with the depth of the reflection position of the ultrasound waves and the envelope detection processing by the signal processing unit 55, the image signal is converted into the image signal in accordance with the normal television signal scanning method by the DSC 56, and the ultrasound image signal is generated by the image processing unit 57 further performing various types of necessary image processing such as gradation processing.

The ultrasound image signal generated in this way is wirelessly transmitted from the wireless communication circuit 21 of the ultrasound probe 11 to the apparatus body 41 and is received by the wireless communication circuit 42 of the apparatus body 41, and then the ultrasound image is displayed on the monitor 44 via the display controller 43.

In such an operation, the heat is generated from the integrated circuit 19 mounted on the circuit board 18, but the heat conduction between the integrated circuit 19 and the heat transfer member 23 is controlled by the heat transfer control member 24, and the heat generated in the integrated circuit 19 is less likely to be transferred to the heat transfer member 23 of a portion located directly above the integrated circuit 19, while the heat is more likely to be transferred to the heat transfer member 23 of a portion located in the periphery of the integrated circuit 19. The heat transferred from the integrated circuit 19 to the heat transfer member 23 is widely conducted into the housing 12 via the sheet-like heat transfer member 23 having high thermal conductivity, and is released to the outside of the ultrasound probe 11 via the housing 12.

Therefore, for example, it is possible to effectively prevent the formation of a so-called heat spot, in which the temperature is locally high, in the housing 12 in a portion located directly above the integrated circuit 19 due to a simple structure in which the sheet-like heat transfer member 23 and the sheet-like heat transfer control member 24 are disposed between the inner surface of the housing 12 and the integrated circuit 19.

Therefore, it is possible to reduce the size of the ultrasound probe 11 while suppressing the increase in temperature due to the heat generated from the integrated circuit 19.

Similarly, it is assumed that the heat is also emitted from the other integrated circuit 20 and the wireless communication circuit 21 mounted on the circuit board 18, but the sheet-like heat transfer control member 24 is also disposed between the integrated circuit 20 and the wireless communication circuit 21 and the heat transfer member 23, and thus, for example, the formation of the heat spot in the housing 12 of the portion located directly above the integrated circuit 20 or the wireless communication circuit 21 is effectively prevented.

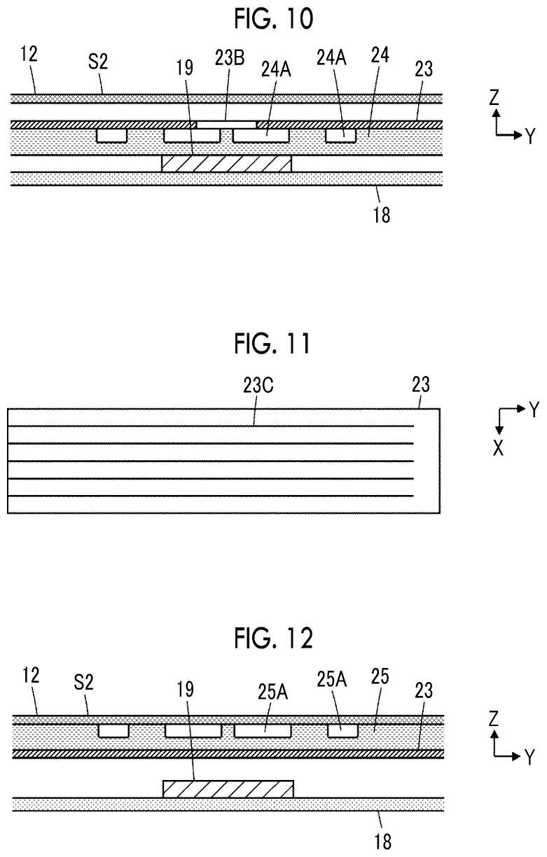

In the ultrasound probe 11 according to the first embodiment, for example, as shown in FIG. 10, the heat transfer member 23 may have at least one opening portion 23B that is located directly above the integrated circuit 19 so as to correspond to the integrated circuit 19. In this manner, a heat conduction path from the integrated circuit 19 to the housing 12 of the portion located directly above the integrated circuit 19 is restricted, and the formation of the heat spot in the portion located directly above the integrated circuit 19 is more effectively prevented.

Similarly, in a case in which the heat transfer member 23 has the opening portions 23B that are located directly above the other integrated circuit 20 and the other wireless communication circuit 21, the formation of the heat spot in the portion located directly above the integrated circuit 20 and the wireless communication circuit 21 is more effectively prevented.

In addition, as shown in FIG. 4, although the wireless communication circuit 21 is covered with the heat transfer member 23 inside the housing 12, the wireless communication circuit 21 transmits and receives radio waves by the built-in wireless communication antenna, so that it is desirable that the heat transfer member 23 has an opening portion at a position corresponding to the wireless communication circuit 21 such that radio waves are not blocked. Instead of the wireless communication antenna built in the wireless communication circuit 21, a wireless communication antenna configured as a separate component from the wireless communication circuit 21 can also be provided. In such a case, it is desirable that the opening portion is provided at a position corresponding to the wireless communication antenna as a separate component.

Similarly, since the power receive coil 17 wirelessly receives the charging power from the charger disposed outside the ultrasound probe 11 in a case of charging the battery 16, in a case in which the heat transfer member 23 also covers the power receive coil 17, it is desirable that the heat transfer member 23 has an opening portion at a position corresponding to the power receive coil 17 such that radio waves are not blocked.

As shown in FIG. 1, an outer surface of the grip portion 12C of the housing 12 includes many portions having a curved shape. Therefore, as shown in FIG. 11, it is preferable that the heat transfer member 23 has a plurality of slits 23C formed in the Y direction along the longitudinal direction of the housing 12. Due to the presence of the plurality of slits 23C, the sheet-like heat transfer member 23 can be disposed along the inner surface of the housing 12 without forming wrinkles, regardless of the shape of the outer surface of the grip portion 12C.

Instead of having the plurality of slits 23C, the heat transfer member 23 may have a tape shape having a width narrower than the width of the housing 12 in the X direction. In this way as well, the heat transfer member 23 can be disposed along the inner surface of the housing 12 without forming wrinkles.

In addition, the sheet-like heat transfer member 23 can be disposed to cover the entire rear surface of the grip portion 12C of the housing 12, and thus the heat dissipation efficiency of the ultrasound probe 11 can be improved.

It should be noted that, since at least a part of the outer surface of the second side plate portion S2, among the first side plate portion S1 to the fourth side plate portion S4 that surround the grip portion 12C, disposed on the side opposite to the first side plate portion S1 with the center line C1 interposed therebetween has a curved shape, the ultrasound probe 11 according to the first embodiment is configured such that the user can easily grip the grip portion 12C and the operability of the ultrasound probe 11 is improved.

In addition, since the protrusion 13 is formed to protrude on the +X direction side of the front end portion 12A of the ultrasound probe 11, the user can easily grasp the orientation of the ultrasound probe 11 due to the presence of the protrusion 13 in a case in which the user grips the grip portion 12C, and the operability is improved.

Further, since the ultrasound probe 11 has the light-emitting unit 14 disposed on the outer surface of the third side plate portion S3 of the grip portion 12C, various states of the ultrasound probe 11 can be notified by changing a way of emitting light from the light-emitting unit 14 under the control of the light emission controller 35.

For example,
Activation state of ultrasound probe 11,
Wireless connection state between ultrasound probe 11 and apparatus body 41,
Remaining capacity of battery 16,
Charging state of battery 16,
Error state, and
Update state of software installed in ultrasound probe 11 are notified by changing the light emission color, the light emission pattern, and the like.

In addition, the temperature of the vicinity of the inner surface of the second side plate portion S2 of the grip portion 12C detected by the two temperature sensors 22 is transmitted to the probe controller 37, and the notification of a heat generation state of the ultrasound probe 11 can be performed by the light emitted from the light-emitting unit 14 under the control of the light emission controller 35.

In general, the surface temperature of the ultrasound probe is limited to a temperature equal to or lower than a temperature predetermined by a safety standard, but, in a case in which the way of the light emission of the light-emitting unit 14 is changed in accordance with the temperature detected by the temperature sensor 22, the user can easily and sensuously grasp the surface temperature of the ultrasound probe 11. In addition, the user may grasp a fact that the surface temperature of the ultrasound probe 11 exceeds a predetermined temperature based on the way of the light emission of the light-emitting unit 14, and may use the fact as a guide for temporarily suspending the use of the ultrasound probe 11.

In a case in which the temperature detected by the temperature sensors 22 has reached a predetermined threshold value, the surface temperature of the ultrasound probe 11 can be lowered by performing a treatment such as adjusting the drive signal supplied from the transmission/reception circuit 31 to the transducer array 15 by the ultrasound transmission/reception controller 33 to lower the frame rate of the ultrasound imaging or stopping the ultrasound imaging.

In the first embodiment described above, the protrusion 13 is formed to protrude on the +X direction side of the front end portion 12A of the ultrasound probe 11, but the present invention is not limited to this, and the protrusion 13 can also be formed to protrude on the −X direction side of the front end portion 12A of the ultrasound probe 11.

Similarly, in the first embodiment described above, the light-emitting unit 14 is disposed on the outer surface of the third side plate portion S3 of the grip portion 12C facing the +X direction, but the present invention is not limited to this, and the light-emitting unit 14 may be disposed on the outer surface of the fourth side plate portion S4 of the grip portion 12C facing the −X direction.

### Second Embodiment

In the first embodiment described above, the sheet-like heat transfer control member 24 is disposed between the heat transfer member 23 and the integrated circuits 19 and 20 and the wireless communication circuit 21, but the present invention is not limited to this.

FIG. 12 shows a configuration of a periphery of the integrated circuit 19 in an ultrasound probe according to a second embodiment of the present invention.

In the vicinity of the integrated circuit 19, a sheet-like heat dissipation control member 25 is disposed between the heat transfer member 23 and the inner surface of the housing 12. Similarly to the heat transfer member 23, the heat dissipation control member 25 consists of a sheet-like member having high thermal conductivity, a front surface of the heat dissipation control member 25 on the +Z direction side is in contact with the inner surface of the housing 12, and a rear surface of the heat dissipation control member 25 on the −Z direction side is in contact with the front surface of the heat transfer member 23.

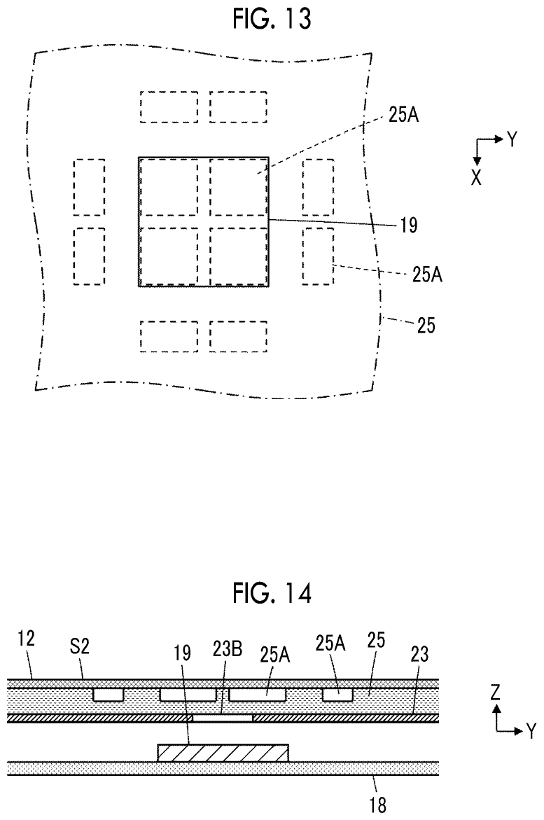

In addition, a plurality of recess portions 25A are formed on a front surface of the heat dissipation control member 25 on the +Z direction side facing the inner surface of the housing 12. The plurality of recess portions 25A are arranged in a pattern corresponding to a position of the integrated circuit 19, and, for example, as shown in FIG. 13, the recess portions 25A are disposed in portions having a large area ratio with respect to the front surface of the integrated circuit 19 directly above the integrated circuit 19, and the disposition of the recess portions 25A is limited to a relatively small area portion in the periphery of the integrated circuit 19.

The front surface of the heat dissipation control member 25 on the +Z direction side is in contact with the inner surface of the housing 12, but since the recess portion 25A is formed on the front surface of the heat dissipation control member 25 on the +Z direction side, the heat dissipation control member 25 and the inner surface of the housing 12 are not in direct contact with each other in a portion in which the recess portion 25A is present.

Therefore, due to the presence of the plurality of recess portions 25A having the arrangement pattern corresponding to the integrated circuit 19, the contact area per unit area, directly above the integrated circuit 19, between the heat dissipation control member 25 and the inner surface of the housing 12 is smaller than the contact area per unit area, in the periphery of the integrated circuit 19, between the heat dissipation control member 25 and the inner surface of the housing 12.

Therefore, the heat generated in the integrated circuit 19 and conducted to the heat transfer member 23 is less likely to be transferred to the housing 12 of the portion located directly above the integrated circuit 19, whereas the heat is more likely to be transferred to the housing 12 of the portion located in the periphery of the integrated circuit 19. As described above, the heat dissipation control member 25 controls the heat dissipation from the heat transfer member 23 to the housing 12.

In addition, the sheet-like heat dissipation control member 25 is also disposed between the heat transfer member 23 and the inner surface of the housing 12 in the vicinity of the integrated circuit 20 and the wireless communication circuit 21 mounted on the circuit board 18. As in a case of the integrated circuit 19, the heat dissipation control member 25 controls the heat dissipation from the heat transfer member 23 to the housing 12 such that the heat generated in the integrated circuit 20 and the wireless communication circuit 21 and conducted to the heat transfer member 23 is less likely to be transferred to the housing 12 of the portion located directly above the integrated circuit 20 and the wireless communication circuit 21, and is more likely to be transferred to the housing 12 of the portion located in the periphery of the integrated circuit 20 and the wireless communication circuit 21.

As in the heat transfer control member 24 in the first embodiment, in a case in which the heat transfer member 23 is made of the copper sheet or the heat dissipation gel, the heat dissipation control member 25 can be made of the heat dissipation gel, the graphite sheet, the aluminum heat sink, the heat dissipation resin, or the like. In addition, in a case in which the heat transfer member 23 is made of the graphite sheet, the heat dissipation control member 25 can be made of the heat dissipation gel, the aluminum heat sink, the heat dissipation resin, or the like.

In the second embodiment as well, the heat transfer member 23 can be made of an anisotropic thermally conductive material having characteristics that the thermal conductivity is higher in the plane direction of the heat transfer member 23 than in the thickness direction of the heat transfer member 23, and in this case, in order to ensure electrical insulation, it is desirable to perform an electrical insulation treatment on at least a portion of a surface of the heat transfer member 23 facing the integrated circuits 19 and 20 and the wireless communication circuit 21.

In addition, the heat transfer member 23 and the heat dissipation control member 25 can be held inside the housing 12, for example, by being interposed between the circuit board 18 and the inner surface of the housing 12.

However, instead of interposing the heat transfer member 23 and the heat transfer control member 24, the heat transfer member 23 and the heat transfer control member 24 may be held inside the housing 12 by, for example, adhering to the inner surface of the housing 12.

In FIG. 12, the rear surface of the heat transfer member 23 on the −Z direction side is separated from the front surface of the integrated circuit 19, but the heat transfer member 23 and the integrated circuit 19 may be in contact with each other.

In a case in which the ultrasound probe 11 is operated, the heat is generated from the integrated circuit 19 mounted on the circuit board 18, but the heat dissipation from the heat transfer member 23 to the housing 12 is controlled by the heat dissipation control member 25, and the heat generated in the integrated circuit 19 is less likely to be transferred to the housing 12 of the portion located directly above the integrated circuit 19, whereas the heat generated in the integrated circuit 19 is more likely to be transferred to the housing 12 of the portion located in the periphery of the integrated circuit 19.

The heat transferred from the integrated circuit 19 to the heat transfer member 23 is widely conducted into the housing 12 via the sheet-like heat transfer member 23 having high thermal conductivity, and is released to the outside of the ultrasound probe 11 via the housing 12.

Therefore, in the ultrasound probe 11 according to the second embodiment as well, for example, it is possible to effectively prevent the formation of a so-called heat spot, in which the temperature is locally high, in the housing 12 in a portion located directly above the integrated circuit 19 due to a simple structure in which the sheet-like heat transfer member 23 and the sheet-like heat dissipation control member 25 are disposed between the inner surface of the housing 12 and the integrated circuit 19.

Therefore, as in the first embodiment, it is possible to reduce the size of the ultrasound probe 11 while suppressing the temperature increase due to the heat generated from the integrated circuit 19.

Similarly, it is assumed that the heat is also emitted from the other integrated circuit 20 and the wireless communication circuit 21 mounted on the circuit board 18, but the sheet-like heat dissipation control member 25 is also disposed between the inner surface of the housing 12 and the heat transfer member 23 in the periphery of the integrated circuit 20 and the wireless communication circuit 21, and thus, for example, the formation of the heat spot in the housing 12 of the portion located directly above the integrated circuit 20 or the wireless communication circuit 21 is effectively prevented.

In addition, as shown in FIG. 14, the heat transfer member 23 may have an opening portion 23B that is located directly above the integrated circuit 19 so as to correspond to the integrated circuit 19.

In this manner, a heat conduction path from the integrated circuit 19 to the housing 12 of the portion located directly above the integrated circuit 19 is restricted, and thus the formation of the heat spot in the portion located directly above the integrated circuit 19 can be more effectively prevented.

Similarly, in a case in which the heat transfer member 23 has the opening portions 23B that are located directly above the other integrated circuit 20 and the other wireless communication circuit 21, the formation of the heat spot in the portion located directly above the integrated circuit 20 and the wireless communication circuit 21 is more effectively prevented.

As shown in FIG. 11, in a case in which the heat transfer member 23 has at least one slit 23C formed in the Y direction along the longitudinal direction of the housing 12, the sheet-like heat transfer member 23 can be disposed along the inner surface of the housing 12 without wrinkles, regardless of the shape of the outer surface of the grip portion 12C.

Instead of having at least one slit 23C, the heat transfer member 23 may have a tape shape having a width narrower than the width of the housing 12 in the X direction.

In the second embodiment as well, the sheet-like heat transfer member 23 can be disposed to cover the entire rear surface of the grip portion 12C of the housing 12, and thus the heat dissipation efficiency of the ultrasound probe 11 can be improved.

### Third Embodiment

The ultrasound probe 11 according to the first embodiment includes the image generation unit 32, and the ultrasound image signal generated by the image generation unit 32 is wirelessly transmitted from the wireless communication circuit 21 of the ultrasound probe 11 to the apparatus body 41 as shown in FIG. 7, but the present invention is not limited to this.

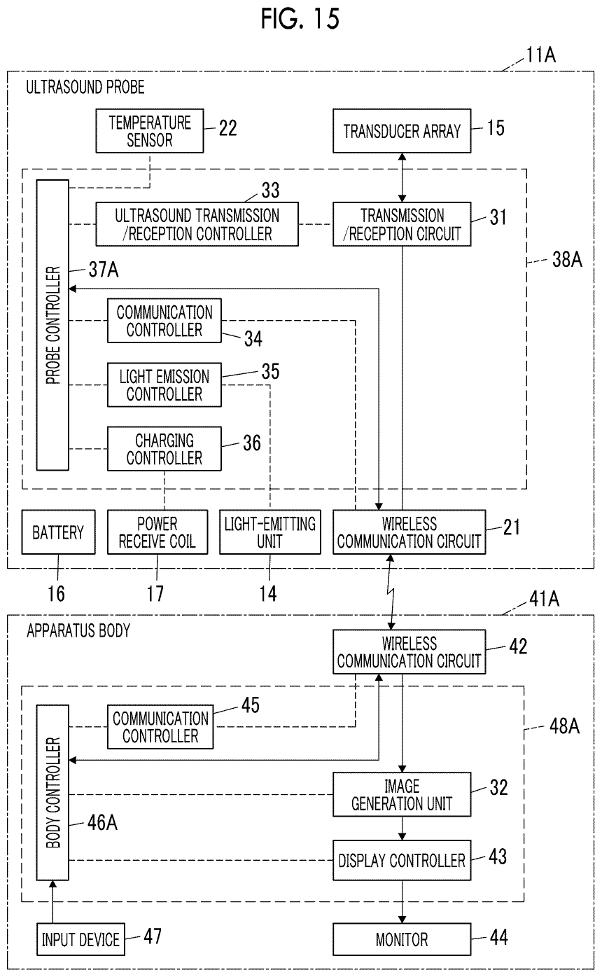

FIG. 15 shows a configuration of an ultrasound diagnostic apparatus comprising an ultrasound probe 11A according to a third embodiment. The ultrasound diagnostic apparatus comprises the ultrasound probe 11A and an apparatus body 41A according to the third embodiment, and the ultrasound probe 11A and the apparatus body 41A are connected to each other by wireless communication.

The ultrasound probe 11A is obtained by deleting the image generation unit 32 in the ultrasound probe 11 according to the first embodiment shown in FIG. 7, directly connecting the wireless communication circuit 21 to the transmission/reception circuit 31, and using a probe controller 37A instead of the probe controller 37, and other configurations of the ultrasound probe 11A are the same as those of the ultrasound probe 11 according to the first embodiment. In addition, the ultrasound probe 11A has the same housing 12 as the housing 12 in the ultrasound probe 11 according to the first embodiment.

The apparatus body 41A is obtained by newly connecting the image generation unit 32 between the wireless communication circuit 42 and the display controller 43 in the apparatus body 41 according to the first embodiment shown in FIG. 7, and connecting the body controller 46A to the display controller 43, the communication controller 45, and the image generation unit 32 instead of the body controller 46, and other configurations of the apparatus body 41A are the same as those of the apparatus body 41 according to the first embodiment.

In the ultrasound probe 11A, the transmission/reception circuit 31, the ultrasound transmission/reception controller 33, the communication controller 34, the light emission controller 35, the charging controller 36, and the probe controller 37A form a processor 38A on the ultrasound probe 11A side.

In addition, in the apparatus body 41A, the image generation unit 32, the display controller 43, the communication controller 45, and the body controller 46A form a processor 48A on the apparatus body 41A side.

The sound ray signal generated in the transmission/reception circuit 31 of the ultrasound probe 11A is wirelessly transmitted from the wireless communication circuit 21 to the apparatus body 41A, the image generation unit 32 performs attenuation correction and envelope detection processing on the sound ray signal received by the wireless communication circuit 42 of the apparatus body 41A to generate the ultrasound image signal, and the ultrasound image is displayed on the monitor 44 via the display controller 43.

In this way, in the ultrasound diagnostic apparatus comprising the ultrasound probe 11A according to the third embodiment as well, the ultrasound image can be displayed on the monitor 44 in the same manner as the ultrasound diagnostic apparatus comprising the ultrasound probe 11 according to the first embodiment.

In addition, in the ultrasound probe 11A, similarly to the ultrasound probe 11 of the first embodiment, the sheet-like heat transfer member 23 and the heat transfer control member 24 are disposed between the inner surface of the housing 12 and the integrated circuit 19, and, for example, the formation of a so-called heat spot, in which the temperature is locally high, on the housing 12 of the portion located directly above the integrated circuit 19 is effectively prevented.

Therefore, it is possible to reduce the size of the ultrasound probe 11A while suppressing the increase in temperature due to the heat generated from the integrated circuit 19.

In addition, as in the second embodiment, even in a case in which the sheet-like heat transfer member 23 and the sheet-like heat dissipation control member 25 are disposed between the inner surface of the housing 12 and the integrated circuit 19, it is possible to reduce the size of the ultrasound probe 11A while suppressing the increase in temperature due to the heat generated from the integrated circuit 19 in the same manner.

The apparatus body 41 according to the first and second embodiments and the apparatus body 41A according to the third embodiment can be a portable thin computer form or a stationary apparatus body.

### EXPLANATION OF REFERENCES

11, 11A: ultrasound probe
12: housing
12A: front end portion
12B: rear end portion
12C: grip portion
13: protrusion
14: light-emitting unit
15: transducer array
15A: ultrasound emission surface
16: battery
17: power receive coil
18: circuit board
19, 20: integrated circuit
21, 42: wireless communication circuit
22: temperature sensor
23: heat transfer member
23A, 23B: opening portion
23C: slit
24: heat transfer control member
24A, 25A: recess portion
25: heat dissipation control member
31: transmission/reception circuit
32: image generation unit
33: ultrasound transmission/reception controller
34, 45: communication controller
35: light emission controller
36: charging controller
37, 37A: probe controller
38, 38A, 48, 48A: processor
41, 41A: apparatus body
43: display controller
44: monitor
46, 46A: body controller
47: input device
51: pulser
52: amplifying unit
53: AD conversion unit
54: beam former
55: signal processing unit
56: DSC
57: image processing unit
C1: center line
S1: first side plate portion
S2: second side plate portion
S3: third side plate portion
S4: fourth side plate portion

What is claimed is:

1. An ultrasound probe in which an integrated circuit is disposed inside a grip portion of a housing, the ultrasound probe comprising:
a heat transfer member that is sheet-like and that is disposed between an inner surface of the housing and the integrated circuit so as to cover at least a periphery of the integrated circuit; and
a heat transfer control member that is sheet-like, that is disposed between the heat transfer member and the integrated circuit so as to cover at least the periphery of the integrated circuit, and that controls heat conduction between the integrated circuit and the heat transfer member,
wherein the heat transfer control member is in contact with the heat transfer member, and
a contact area per unit area, directly above the integrated circuit, between the heat transfer control member and the heat transfer member is smaller than a contact area per unit area, in the periphery of the integrated circuit, between the heat transfer control member and the heat transfer member.

2. The ultrasound probe according to claim 1,
wherein the heat transfer member has at least one opening portion located directly above the integrated circuit.

3. The ultrasound probe according to claim 1,
wherein the heat transfer member is made of an anisotropic thermally conductive material having thermal conductivity higher in a plane direction thereof than in a thickness direction thereof.

4. The ultrasound probe according to claim 1,
wherein at least a portion of a surface of the heat transfer member facing the integrated circuit is subjected to an electrical insulation treatment.

5. The ultrasound probe according to claim 1,
wherein the heat transfer member is disposed to cover an entire rear surface of the grip portion of the housing.

6. The ultrasound probe according to claim 5,
wherein the heat transfer member has at least one slit formed along a longitudinal direction of the housing.

7. The ultrasound probe according to claim 5,
wherein the heat transfer member has a tape shape with a width narrower than a width of the housing.

8. The ultrasound probe according to claim 1, further comprising:
at least one of a temperature sensor or a wireless communication circuit,
wherein the heat transfer member is disposed so as to cover at least one of the temperature sensor or the wireless communication circuit, and
the heat transfer member has an opening portion corresponding to at least one of the temperature sensor or the wireless communication circuit.

9. The ultrasound probe according to claim 1,
wherein the heat transfer control member has a plurality of recess portions formed on a surface that faces the heat transfer member, and
the plurality of recess portions are arranged in a pattern corresponding to a position of the integrated circuit.

10. An ultrasound probe in which an integrated circuit is disposed inside a grip portion of a housing, the ultrasound probe comprising:
a heat transfer member that is sheet-like and that is disposed between an inner surface of the housing and the integrated circuit so as to cover at least a periphery of the integrated circuit; and
a heat dissipation control member that is sheet-like, that is disposed between the heat transfer member and the inner surface of the housing so as to cover at least the periphery of the integrated circuit, and that controls heat dissipation from the heat transfer member to the housing,
wherein the heat dissipation control member is in contact with the inner surface of the housing, and
a contact area per unit area, directly above the integrated circuit, between the heat dissipation control member and the inner surface of the housing is smaller than a contact area per unit area, in the periphery of the integrated circuit, between the heat dissipation control member and the inner surface of the housing.

11. The ultrasound probe according to claim 10,
wherein the heat transfer member has at least one opening portion located directly above the integrated circuit.

12. The ultrasound probe according to claim 10,
wherein the heat transfer member is made of an anisotropic thermally conductive material having thermal conductivity higher in a plane direction thereof than in a thickness direction thereof.

13. The ultrasound probe according to claim 10,
wherein at least a portion of a surface of the heat transfer member facing the integrated circuit is subjected to an electrical insulation treatment.

14. The ultrasound probe according to claim 10,
wherein the heat transfer member is disposed so as to cover an entire rear surface of the grip portion of the housing.

15. The ultrasound probe according to claim 14,
wherein the heat transfer member has at least one slit formed along a longitudinal direction of the housing.

16. The ultrasound probe according to claim 14,
wherein the heat transfer member has a tape shape with a width narrower than a width of the housing.

17. The ultrasound probe according to claim 10, further comprising:
at least one of a temperature sensor or a wireless communication circuit,
wherein the heat transfer member is disposed so as to cover at least one of the temperature sensor or the wireless communication circuit, and
the heat transfer member has an opening portion corresponding to at least one of the temperature sensor or the wireless communication circuit.

18. The ultrasound probe according to claim 10,
wherein the heat dissipation control member has a plurality of recess portions formed on a surface that faces the inner surface of the housing, and
the plurality of recess portions are arranged in a pattern corresponding to a position of the integrated circuit.
